(19) United States
(12) Patent Application Publication
(10) Pub. No.: US 2004/0182780 A1
(43) Pub. Date: Sep. 23, 2004

(54) Organic waste treatment apparatus and method for recycling as a liquid fertilizer

(75) Inventor: Myung-Gyu Lee, Gangwon-do (KR)

Correspondence Address: MARGER JOHNSON & MCCOLLOM PC, 1030 SW MORRISON STREET, PORTLAND, OR, 97205, US

(73) Assignee: TAO CO., LTD., Wonju-si (JP)

(21) Appl. No.: 10/686,961

(22) Filed: Oct. 15, 2003

(30) Foreign Application Priority Data
Oct. 21, 2002 (KR) P2002-64229

(51) Int. Cl. C02F 3/02

(52) U.S. Cl. 210/610; 210/612; 210/620; 210/175; 210/209

(57) ABSTRACT

An apparatus for treating organic wastes material and a method for recycling as a liquid fertilizer is disclosed, in which the parasites and pathogens are all annihilated, and the treatment can be carried out at a relatively low cost. The aerobic thermophilic digestion bacteria are added into a closed treatment tank, and the tank accommodates an organic wastes slurry which includes animal manure, kitchen waste, sewage and the like. Then the treatment tank is aerated for promoting the proliferation of the aerobic thermophilic digestion bacteria. Thus, the organic wastes slurry is treated with a thermophilic fermentation. Then photo-tropic bacteria are added to convert the organic waste slurry into a liquid fertilizer. The slurry type organic waste are decomposed by utilizing the aerobic thermophilic digestion bacteria which stably flourishes at about 60° C. Then the decomposing is continued by utilizing the photo-tropic bacteria, thereby finally obtaining the product in the form of a liquid fertilizer. The decomposing treatment can be continued for a long time at a high temperature, and the fermentation can be finished in a relatively short period of time without generating any foul odors. Further, parasites and pathogens can all be annihilated.

### FIELD OF THE INVENTION

The present invention relates to an apparatus for treating an organic waste material and method for recycling as a liquid fertilizer, in which organic waste slurries such as animal manures, kitchen wastes, sewage and the like are ferment-treated.

### BACKGROUND OF THE INVENTION

A method for treating organic waste slurries such as animal manures, kitchen wastes, sewage and the like is disclosed in Japanese Patent Publication No. Hei-8-11239.

In this invention, organic wastes in animal manure are accommodated in a treatment tank. Photo-tropic bacteria are then added into the tank, and the tank is left exposed to the atmospheric air. Then, foams are occurred on the surface of the tank, and decomposition-resistant organic materials such as saw dusts are added to the surface of the foams.

The foams are removed by using a foam removing apparatus, and at the same time, the organic waste slurry with the decomposition-resistant organic materials are taken out of the tank. Thus, the organic materials except the decomposition-resistant materials are ferment-treated by the microbes mainly of a photo-tropic bacteria.

In this conventional technique, however, a secondary pollution or contamination can be caused when the organic waste slurry with the decomposition-resistant materials (adhered on the foams) are taken out of the tank. In order to solve this problem, the organic waste slurry has to be further treated.

The photo-tropic bacteria which contribute to decomposing the organic waste materials such as animal manures is the medium range temperature (semi-thermophilic) microbes in general. Accordingly, the fermentation of the animal manure within the treatment tank is called as medium range temperature (semi-thermophilic) fermentation.

Accordingly, in the described method, the activities of the general (the usual nature) anaerobic microbes cannot be inhibited (they proliferate regardless of the presence of oxygen), and therefore, foul odor is generated. Although the generated odor can be absorbed with using a deodorizing agent such as a zeolite, in actual, the complete deodorization of the foul odor is impossible and the cost increases.

Further, in the mentioned method belongs to the medium range temperature fermentation, the parasite and the pathogen such as a Criptostridium cannot be eliminated. Therefore, the alleged effect of the mentioned invention “the dried slurry after the fermentation can be utilized to improve the soil quality” can be achieved only after the pathogenic microbes have been annihilated.

### SUMMARY OF THE INVENTION

The present invention provides an apparatus for treating organic waste and method for producing a liquid fertilizer, in which foul odor is inhibited as much as possible.

The present invention also provides an apparatus for treating organic waste and method for producing a liquid fertilizer, in which parasites and pathogenic microbes are sterilized, and a low operating cost.

In achieving the above objects, the present invention is constituted as follows.

That is, a method for treating the slurry type organic waste to produce a liquid fertilizer according to the present invention includes the steps of: adding the aerobic thermophilic digestion bacteria into a closed treatment tank, the tank accommodating an organic waste slurry; aerating the treatment tank for promoting a proliferation of the aerobic thermophilic digestion bacteria to treat the organic waste slurry with a thermophilic fermentation; and adding photo-trophic bacteria so as to convert the organic waste slurry into a liquid fertilizer.

In another aspect of the present invention, an apparatus for treating the slurry type organic waste to produce a liquid fertilizer according to the present invention includes: a closed treatment tank for accommodating an organic waste slurry; a group of microbes comprising photo-tropic bacteria and aerobic digestion bacteria; means for putting the microbes into the closed treatment tank; and an oxygen supply means for supplying oxygen into the closed treatment tank.

Waste such as an animal manure, a kitchen waste, a sewage and the like, as objects that are to be treated include not only a high water-content slurry but also relative low water-content organic waste such as a food waste. In the case of the latter, the water is added into the organic waste to make it a slurry type waste.

### BRIEF DESCRIPTION OF THE DRAWINGS

The above objects and other advantages of the present invention will become more apparent by describing in detail the preferred embodiment of the present invention with reference to the attached drawings, in which:

FIG. 1 illustrates the phylogenetic tree of Bacillus sp. AURACE-S;

FIG. 2 schematically illustrates the constitution of the preferred embodiment of the apparatus according to the present invention;

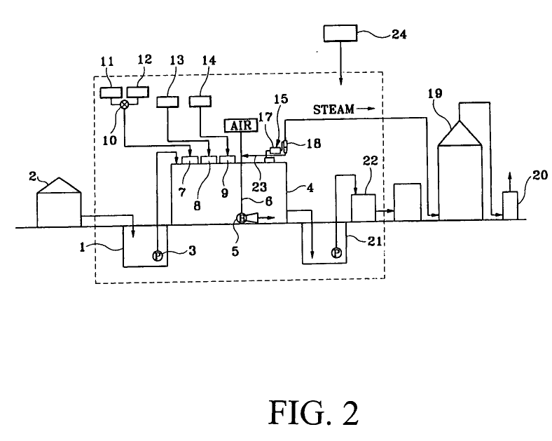

FIG. 3 is a graphical illustration showing the temperature variations of the swine slurry manure with respect to the proliferation of the aerobic thermophilic digestion bacteria; and

FIG. 4 is an enlarged view of a foam removing apparatus for the apparatus of FIG. 2.

### DETAILED DESCRIPTION OF THE PREFERRED EMBODIMENT

The aerobic thermophilic digestion bacteria (AURACE-S) are the microbes present in the organic waste materials, and they were extracted to examine their nature. The results thus found are as follows.

Experimentation Method and Apparatus

The extraction source was the soil sampled out from a pig farm near the residence of the present inventor. The culture medium was the pearl core standard agar medium that was made by YOUNGYEON Chemicals, Co., Ltd. The thermophilic microbes were isolated at a temperature of 55° C.

Further, except the gram's stain test, the morphology judgment was carried out after overnight culture. The gram's stain was carried out by using nutritional cells which had been obtained after growing for 4˜5 hours at optimal conditions.

Measurement of GC Content

Cultivating Conditions:

Isolated microbes were inoculated to a liquid culture medium containing 0.1% of glucose plus Heart-Infusion Broth made by DIFCO, and the culture was carried out by agitating over one night. Then the growth status was checked, and the cultured liquid medium that showed an adequate growth was adopted as the seed microbes.

10% of the seed culture of the isolated microbes was added onto a fresh medium, and the culture was carried out at a temperature of 55° C for 2˜3 hours, and used as the test sample for measurement of GC content.

Extraction of DNA:

(1) 10 ml of the test sample was made to undergo a centrifugal separation to concentrate microbes. Then they were suspended in saline-EDTA, the centrifugal separation was carried out at 10,000×g, and the supernatant was discarded.

(2) The microbes were rapidly frozen with methanol-dry ice.

(3) 0.5 ml of Rizothium 2 mg/ml-10 mM Tris-HC1(pH 8.0) was added, and the reaction was carried out at 37° C. for 30 min˜2 hours.

(4) Tris-SDS buffer solution was added by an amount of 50 μl, and mixed thoroughly. Then heating was carried out at 60° C. for 5 minutes.

(5) 0.2 ml of Phenol 90% (v/v) was added, and an agitation was strongly carried out.

(6) Cooling was carried out in cold water, and then 0.2 ml of chloroform was added and strong agitation were carried out.

(7) A centrifugal separation was carried out for 5 minutes at 10,000×g.

(8) 0.4 ml of the supernatant was sucked out in such a manner that the precipitates of the middle layer would not be sucked, and it was transferred to a separate polypropylene tube.

(9) 0.5 ml of chloroform was added to agitate for 2 minutes, and a centrifugal separation was carried out at 10,000×g.

(10) 0.3 ml of the supernatant was sucked out in such a manner that the precipitates of the middle layer would not be sucked, and it was transferred to a separate polypropylene tube.

(11) Steps (9) and (10) were repeated.

(12) 50 ml of RNase solution was added, and a reaction was carried out at 37° C. for 10 minutes.

(13) 50 ml of Proteinase K solution was added, and a reaction was carried out at 37° C. for 20 minutes.

(14) 0.2 ml of 90% phenol and 0.2 ml of chloroform were added, and stirring were carried out for 1 minute.

(15) A centrifugal separation was carried out for 5 minutes at 10,000×g, and 0.3 ml of the supernatant was transferred to a polypropylene tube.

(16) 0.7 ml of 99% ethanol was added, and stirring were carried out for 1 minute.

(17) The precipitated DNA was rinsed with 70% ethanol and 99% ethanol in a sequential manner.

(18) Drying was carried out with a pressure decreasing decicater.

Preparation of the Test Sample for the Measurement of the GC Content

(1) 50 μl of a sterilized distilled water was added to the test sample of the step (18) above, and it was left for one hour and half at 60° C. Thereafter, it was heated to 100° C. for 5 minutes, and then was subjected to rapid cooling.

(2) It was then placed into polypropylene tubes by 10 μl each time.

(3) A Nuclease P1 solution was added by 10 μl each time, and the lid was closed. Light stirring was carried out, and then it was subjected to a centrifugal separation for several seconds.

(4) It was reacted at 50° C. for one hour.

(5) An alkaline phosphatase solution was added by 10 μl each time, and the lid was closed. Light stirring was carried out, and then it was subjected to a centrifugal separation for several seconds.

(6) It was reacted at 37° C. for one hour.

(7) This solution (as it is) was taken as the sample for HPLC.

Operating Conditions for HPLC

(1) Column: Chemical Product Inspection Society No. L-column ODS

(2) Eluted fluid: 0.2M NH₄H₂PO₄-acetonitrile=20:1

(3) Flow velocity: 0.5 ml/min, Detector: UV spectrometer

(4) Detected wavelength: 260 nm

(5) Temperature: room temperature

Calculation of GC Content

The calculation of the GC content was carried out based on the following formula:

GC(mol %)=(Gx+Cx/Ax+Tx+Gx+Cx)×x100

where Cx(Gx, Tx, Ax) indicates the peak area of dCMP(dGMP, dTMP, dAMP) of the DNA which was digested by the Nuclease P1.

Preparation of PCR Products

The PCR reaction was carried out under the following conditions.

Composition of the reacting solution:

| | |
|---|---|
| PCR Master Mix | 25.0 μL |
| Genomic DNA & Posi/Nega Controls | 1.0 μL |
| DW | 24.0 μL |

PCR conditions.

The thermal cycler was GeneAmp PCR System 9700.

The cycling was carried out under the following conditions:

| Temperature (° C.) | Time | Number of cycles |
|---|---|---|
| 95 | 10 min | 1 |
| 95 | 30 sec | 30 |
| 60 | 30 sec | 30 |
| 72 | 45 sec | 30 |
| 72 | 10 min | 1 |
| 4 | ∞ | ∞ |

Purification after PCR Reaction

MICROCON 100 Column (made by MILLIPORE company) was used.

Cycle sequence reaction

The reaction was carried out with using the MICROSEQ 500 16S rDNA Bacterial Sequencing Kit.

The sequencing module was as follows.

Composition of reaction solution:

| | |
|---|---|
| Purified PCR Products | 3.0 μL |
| Forward or Reverse Sequencing Mix | 13.0 μL |
| DW | 4.0 μL |

Cycling Conditions

The thermal cycler was GeneAmp PCR System 9700.

The cycling was carried out under the following conditions:

| Temperature (° C.) | Time | Number of cycles |
|---|---|---|
| 96 | 1 min | 1 |
| 96 | 10 sec | 25 |
| 50 | 5 sec | 25 |
| 60 | 4 min | 25 |
| 4 | ∞ | ∞ |

Purification after Cyclic Sequence Reaction

Purification was carried out with using the CENTRISEP Spin Column.

Method of analysis

The analysis was carried out under the following conditions.

Analyzing apparatus: ABI PRISM 3100 Genetic Analyzer

Capillary: 3100 50 cm Capillaries(61 cm×50 μm)

Polymer: 3100 POP6

Sample dissolution buffer: Hi Di Formamide 10 μL

Interpretation of the base sequence of 16S-rDNA:

The interpretation of the base sequence was carried out with using the DNASIS

Pro (made by Hitachi Software Engineering Ltd.).

Experiment Results

The features of the Bacillus sp. AURACE-S which had been cultured at 55° C. was as follows:

1. Shape and Size

The cell was an elongated form, and the minor axis was 1.0˜1.2 μm, while the major axis was 8˜10 μm.

2. Gram's Stain

The Gram's stain showed to be positive.

3. Presence of spore-forming capability

They formed spores.

4. Movement Feature

They did not have the movement features.

As seen in the above results, this isolated AURACE-S was absolutely aerobic gram-positive microbes, and showed the spore-forming capability. Therefore, it was judged to be Bacillus genus, and named “Bacillus sp. AURACE-S”.

Below, the microbes of IFO (Institute of Fermentation Organization) 1225, 12983, and 13737 (B. stearothermophilus) were designated as the contrasting microbes as against Bacillus sp. AURACE-S of the present invention.

5. Growth state (55° C.)

| Bacillus sp. | | | |
|---|---|---|---|
| AURACE-S | 12550 | 12983 | 13737 |

1 Meat-fluid agar plate growth

| | | | | |
|---|---|---|---|---|
| Growth | Adequate | Adequate | Adequate | Adequate |
| Color | White-yellow | White-yellow | White-yellow | White-yellow |
| Shine | Non-shining | Shining | Shining | Shining |
| | Dry | Wet | Wet | Wet |
| | Shrank | Shrank | Shrank | Shrank |
| Diffusing | None | None | None | None |
| Pigment | | | | |

2 Meat-fluid agar inclined growth

| | | | | |
|---|---|---|---|---|
| Growth | Adequate | Adequate | Adequate | Adequate |
| Color | White-yellow | White-yellow | White-yellow | White-yellow |
| Shine | Non-shining | Shining | Shining | Shining |
| | Dry | Wet | Wet | Wet |
| | Shrank | Shrank | Shrank | Shrank |
| Diffusing | None | None | None | None |
| Pigment | | | | |

3 Meat-fluid liquid growth

| | | | | |
|---|---|---|---|---|
| Surface | No Spore | No Spore | No Spore | No Spore |
| growth | | | | |
| Presence | | | | |

4 Litmus milk

| | | | | |
|---|---|---|---|---|
| pH | No Change | No Change | No Change | No Change |
| Solidification | — | — | — | — |
| Liquefaction | — | — | — | — |

6. Growth temperature

TABLE 1
Comparison of Bacillus sp. AURACE-S to B.
stearothermophilus as to their growth temperature

| Growth | Bacillus sp. | | | |
|---|---|---|---|---|
| temp | AURACE-S | 12550 | 12983 | 13737 |
| 28° C. | − | − | − | − |
| 37° C. | − | − | − | − |
| 40° C. | ++ | − | − | − |
| 45° C. | ++ | + | + | + |
| 50° C. | +++ | +++ | ++ | ++ |
| 55° C. | +++ | +++ | ++ | +++ |
| 60° C. | +++ | +++ | +++ | +++ |
| 65° C. | ++ | +++ | +++ | +++ |

7. Growth pH

TABLE 2
Comparison between Bacillus sp. AURACE-S and
B. stearothermophilus as to their growth pH.

| | Bacillus sp. | | | |
|---|---|---|---|---|
| Growth pH | AURACE-S | 12550 | 12983 | 13737 |
| pH | | | | |
| 4 | − | − | − | − |
| 5 | − | + | + | + |
| 6 | +++ | + | ++ | +++ |
| 7 | +++ | +++ | ++ | +++ |
| 8 | ++ | +++ | +++ | +++ |
| 9 | ++ | +++ | +++ | +++ |
| 10 | ++ | ++ | +++ | +++ |

8. Shape of spores

TABLE 3
Shape of spores of Bacillus sp. AURACE-S

| | Bacillus sp. AURACE-S | B. stearothermophilus |
|---|---|---|
| Sporangium Swollen | + | + |
| Spore shape | E | E |
| Spore position | T | T |

As apparent in Tables 1˜3, Bacillus sp. AURACE-S was surely different from B. stearothermophilus in their surface shape, their growth temperature range, and in their growth pH range. The base composition ratios of the Bacillus sp. AURACE-S and B. stearothermophilus were examined by using the HPLC.

TABLE 4
GC content of Bacillus sp. AURACE-S

| Microbe | GC content(mol %) |
|---|---|
| Bacillus sp. AURACE-S | 63.5 |
| B. stearothermophilus | 43.0 |

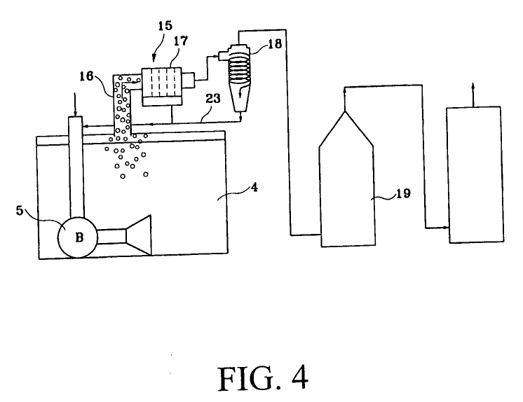

As shown in FIG. 4, the GC content of Bacillus sp. AURACE-S was 63.5 mol %, whereas the GC content of B. stearothermophilus was 43.0 mol %, those are quite different.

Tables 5 and 6 show the 1˜510 base sequences of the 16s-rDNA of Bacillus sp. AURACE-S and B. stearothermophilus.

TABLE 5

1˜510 base sequences of the 16s-rDNA of Bacillus sp. AURACE-S
AGGNNGAACGCTGNGCGGCGNTGTCCTAATACATGTCAAAGTCGAGCGAACCGGATGGAGTGCTTGCATTCC
TGAGGTTAGCGGCGGACGGGTGAGTAACACGTAGGCAACCTGCCTGTACGACCGGGATAACTCCGGGAAACC
GGAGCTAATACCGGATAGGATGCCGAACCGCATGGTTCGGCATGGAAAGGCCTTTGAGCCGCGTACAGATGG
GCCTGCGGCGCATTAGCTAGTTGGTGGGGTAACGGCCTACCAAGGCGACGATGCGTAGCCGACCTGAGAGGG
TGAACGGCCACACTGGGACTGAGACACGGCCCAGACTCCTACGGGAGGCAGCAGTAGGGAATCTTCCGCAAT
GGACGAAAGTCTGACGGAGCAACGCCGCGTGAGTGAGGAAGGTCTTCGGATCGTAAAACTCTGTTGTCAGGG
AAGAACCGCCGGGATGACCTCCCGGTCTGACGGTACCTGACGAGAAAGCCCCGGCTAACTACGTGTCANCAN
CCGCGG

TABLE 6

1˜510 base sequences of the 16s-rDNA of B.stearothermophilus
AACGCTGGCGGCGTGCCTAATACATGCAAGTCGAGCGGACCGGATTGGGGCTTGCTTTGATTCGGTCAGCGG
CGGACGGGTGAGTAACACGTGGGCAACCTGCCCGCAAGACCGGGATAACTCCGGGAAACCGGAGCTAATACC
GGATAACACCGAAGACCGCATGGTCTTCGGTTGAAAGGCGGCCTTTGGGCTGTCACTTGCGGATGGGCCCGC
GGCGCATTAGCTAGTTGGTGAGGTAACGGCTCACCAAGGCGACGATGCGTAGCCGGCCTGAGAGGGTGACCG
GCCACACTGGGACTGAGACACGGCCCAGACTCCTACGGGAGGCAGCAGTAGGGAATCTTCCGCAATGGGCGA
AAGCCTGACGGAGCGACGCCGCGTGAGCGAAGAAGGCCTTCGGGTCGTAAAGCTCTGTTGTGAGGGACGAAG
GAGCGCCGTTCGAAGAGGGCGGCGCGGTGACGGTACCTCACGAGAAAGCCCGGCTAACTACGTGCCAGCAGC
CGCGGT

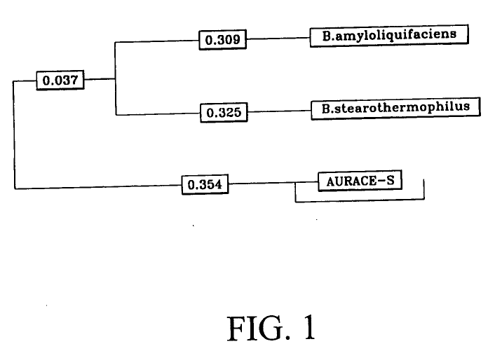

FIG. 1 illustrates that multiple-alignments are carried out in the results of Tables 5 and 6, and the phylogenic tree of Bacillus sp. AURACE-S is prepared.

As apparent in this drawing, it was known from the phylogenic tree that Bacillus sp. AURACE-S is a microbe different from B. stearothermophilus.

Based on the above results, Bacillus sp. AURACE-S was judged to be a new kind of microbe, and it was named Bacillus sp. AURACE-S. Then the microbe was entrusted to the patentable microbe entrust center of the General Industrial Technology Research Center. The entrusting number was FERM P-18769.

As described above, Bacillus sp. AURACE-S is well grown at 55° C., and is capable of treating the organic waste slurry.

The photo-trophic bacteria which are added into the treatment tank are typically as follows.

(1) Rhodobacter Capsulata

Behavior to enzyme (Oxygen demand for growth): absolutely aerobic.

Growth temperature: 20° C.˜40° C.

Characteristics: \mathring{1} decomposition and removal of BOD component

\mathring{2} Decomposition of toxic amine (ptolesine, cadabelyn, dimethylnitrisamine)

\mathring{3} Indirect inhibition of growth of sulfuric acidic reduction microbes owing to ingestion of nutritional salt(prevention of formation of hydrogen sulfide in paddy fields)

\mathring{4} Maintenance of sugar level and freshness, and improvement of the reaping amount owing to the effective components within the microbes.

\mathring{5} Increase of the beneficent microbes by applying to soils.

The items \mathring{4} and \mathring{5} are effective even with the dead microbes of the photo-tropic bacteria.

(2) Rhodobacter Sphaeroides

Behavior to oxygen: absolutely aerobic

Growth temperature: 20° C.˜40° C.

Characteristics: \mathring{1} decomposition-removal of BOD components

\mathring{2} Some have a denitrifying action. (Transformation of nitric acid and nitrous acid into nitrogen gas)

\mathring{3} Decomposition and removal of short chain fatty acid

(3) Rhodopseudomonas gelatinosa and Rhodopseudomonas palustris

Behavior to oxygen: anaerobic

Growth temperature: 20° C.˜40° C.

Characteristics: \mathring{1} decomposition-removal of BOD components

\mathring{2} Absorption of phosphoric acid

These photo-tropic bacteria are well grown under the environment of 20° C.˜40° C., and therefore, they are added into the treatment tank when the fermentation by Bacillus sp. AURACE-S has become stable, and the temperature has been lowered. One kind or a combination of the photo-tropic bacteria can be used in the present invention.

The photo-tropic bacteria of Rhodopseudomonas genus can be grown regardless of the presence or absence of oxygen. Rhodobacter sphaeroides are effective in decomposing and removing the short chain fatty acid, and therefore, it is suitable for the case where deodorizing is required.

Further, if the photo-tropic bacteria are proliferated, the activities of other low temperature or medium temperature microbes are restricted, and therefore, when the temperature is lowered during the treatment, the overall generation of foul odor is inhibited.

Although the amount of the photo-tropic bacteria and the -aerobic thermophilic digestion bacteria which are to be added into the treatment tank should not be particularly limited but it is preferable to be limited to 0.1˜0.3% of the waste slurry (volume to volume).

In addition to the aerobic thermophilic digestion bacteria and the photo-trophic bacteria, nutrients should preferably be added to the microbes. The nutrient source includes wheat, rice bran, and others for the growth of the microbes.

Fermentation of the organic waste slurry results in the treated product in which the organic solids are decomposed, the water component is evaporated, and the total volume is reduced.

A microbe proliferation-inhibiting means should preferably be applied to the treated product.

The microbe proliferation-inhibiting means, for example, consists of a pH-adjusting agent. This pH-adjusting agent adjusts the pH of the treated product to over 10 or to below 3.

The apparatus according to the present invention further includes: a means for adding the nutrient source to the mentioned microbes and/or a means for adding the pH-adjusting agent.

The apparatus according to the present invention further includes: means for removing the foams that are produced in the treatment tank. The decomposition-resistant organic slurry in which the foams have been removed by the means for removing the foams should be preferably recycled to the treatment tank.

Further, in the apparatus of the present invention, at the initial stage of the operation, the slurry type organic waste materials are heated to a certain temperature at which the aerobic thermophilic digestion bacteria can be well proliferated. Thus, the period of being active of the medium temperature microbes such as the anaerobic microbes may well be shortened.

### EXAMPLE

Hereinafter, the present invention will be described based on the preferred embodiment as illustrated in the attached drawings.

FIG. 1 is a conceptive view of the apparatus according to the present invention.

In the drawing, reference code 1 indicates a reservoir for the slurry type organic waste materials that includes the swine manure produced by a pig house 2. Reference code 3 indicates an inlet pump that is installed in the reservoir 1, and reference code 4 indicates the treatment tank for ferment-treating the slurry type organic waste after being press-carried by the pump 3.

The treatment tank 4 is closed except the various additive feeding holes 7˜9.

Within the treatment tank, there is installed a blower or ejector type agitating pump 5. The blower or the ejector type agitating pump 5 supplies air from under the slurry type organic waste which are contained within the treatment tank 4. Reference code 6 indicates an air supply tube which is connected to the blower or the ejector type agitating pump 5, and an end of which extends to the treatment tank 4.

The treatment tank 4 is provided with the various additive feeding holes 7˜9. The first feeding hole 7 is for the entry of the aerobic thermophilic digestion bacteria and the photo-tropic bacteria. The aerobic thermophilic digestion bacteria are a new kind of microbe which belongs to the Bacillus genus, and these microbes are well proliferated above 45° C., being absolutely aerobic microbes.

In the present invention, the photo-tropic bacteria are a combination of Rhodobacter capsuluter, Rhodobacter sphaeroides, and Rhodoschdomonas gelatinosa. Any one of the aerobic thermophilic digestion bacteria and the photo-tropic bacteria are selectively supplied into the treatment tank according to a switching valve 10 which is installed at an intermediate position of the supply tube.

The aerobic thermophilic digestion bacteria are added through the first feeding hole 7 into the treatment tank at the initial stage of the treatment, while the photo-tropic bacteria are added through the first feeding hole 7 in the same manner at the later stage of the treatment.

The amount of the two sets of the microbes added depends on the amount of the slurry type organic waste. Usually, the aerobic thermophilic digestion bacteria or the photo-tropic bacteria are added in an amount of about 0.1˜0.3% (volume %) relative to the total amount of the slurry type organic waste.

In the drawing, reference code 11 indicates a vessel for accommodating the aerobic thermophilic digestion bacteria, and reference code 12 indicates a vessel for accommodating the photo-tropic bacteria.

Reference code 8 indicates a second feeding hole that communicates to an accommodator 13 for wheat or rice bran as the nutrient for the two sets of the microbes. At an appropriate time, these nutritional sources are supplied through the second feeding hole 8.

Reference code 9 indicates a third feeding hole that communicates to a pH adjustment agent accommodator 14, the agent being a means for inhibiting the proliferation of the microbes. When it is time for the pH-adjusting agent to be added, the pH-adjusting agent is fed into the treatment tank through the third feeding hole 9.

Reference code 15 indicates an air pore remover that is installed on the top of the treatment tank. As shown in the enlarged view of FIG. 4, this foam remover 15 includes: a foam introducing tube 16 communicating to the interior of the treatment tank; a surrounding filter 17, and a cyclone 18.

The bottom of the cyclone 18 communicates through a tubular carrier path 23 to the foam supply tube 6. Accordingly, the suction force of the interior of the cyclone acts toward the outlet of the tubular carrier path rather than toward the inlet of the surrounding filter due to the negative pressure of the blower or the ejector-type agitating pump 5.

Reference code 19 indicates a cleaning tower that communicates through a communicating path to the top of the cyclone 18. A deodorizing tower 20 stands beside the cleaning tower 19.

Reference code 21 indicates a reservoir for the liquid fertilizer, and 22 indicate a vibrator.

Reference code 24 indicates a controller which includes a control circuit for driving and controlling the amounts and times of supplying the various additives such as the photo-tropic bacteria, the aerobic thermophilic digestion bacteria, the pH-adjusting agent, the nutritional source and the like, and for controlling the driving of the blower or the ejector type agitating pump.

Hereinafter, the apparatus of the present invention will be described as to its operation.

The slurry type pig house excretion manure stored in the reservoir is supplied into the treatment tank through the pump 3 in an amount of 6 m³ by manipulating the controller 24. The aerobic thermophilic digestion bacteria are supplied through the first feeding hole 7 into the treatment tank in an amount of 20L (liters), and then, the blower 5 is driven to supply the external air to the slurry so as for the slurry to be exposed to the air.

The aerobic microbes that are present within the slurry initiate their activities under the solute oxygen to decompose the organic materials so as to raise the temperature of the slurry.

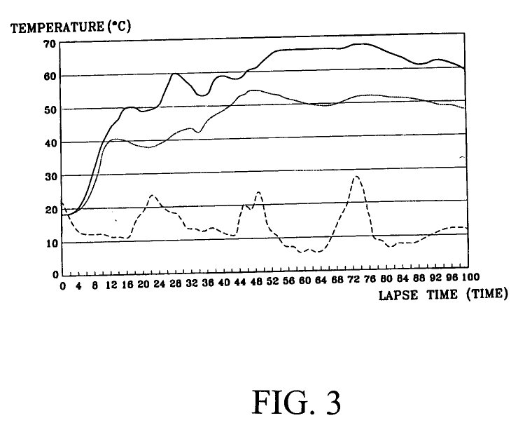

In FIG. 3, the thick solid line shows the variations of temperature in the case where the aerobic thermophilic digestion bacteria are added into the slurry, and the thin dotted line shows the variations of the slurry temperature in the case where they are not added, while the long dotted line shows the variations of the temperature of the external air.

Over the period of 10 hours after the aeration, the same temperature rise is seen in both the case where the aerobic thermophilic digestion bacteria are supplied, and where they are not supplied. The temperature of the slurry rises up to 40° C. over the period of 10 hours.

As described above, the aerobic thermophilic digestion bacteria initiates the growth at the time of being over 37° C. Due to the proliferation of the aerobic thermophilic digestion bacteria, the temperature of the slurry further rises to about 50° C. over the period of 16 hours.

The aerobic thermophilic digestion bacteria are continuously active even after that, and therefore, in 28 hours, the slurry temperature rises up to 60° C. Thereafter, over the period of 96 hours (four days), a temperature of 60° C. is maintained in average (the peak temperature being 68° C.).

Under this high temperature environment, the various pathogenic microbes such as E. coli present within the slurry are all annihilated.

For both the manure and the liquid fertilizer, measurements were carried out with using a BTB agar medium, to find the number of E. coli. The findings showed that the number of E. coli in the manure was 10⁵, but the liquid fertilizer showed a negative result.

Further, another test was performed for the criptospolydium based on the indirect fluorescent antibody dyeing method [a tentative test method for the water supply system]. This test for the manure showed a positive result, while the test for the liquid fertilizer after the treatment showed a negative result.

This confirmed that the long maintenance of the high temperature environment killed all of the pathogenic microbes.

Meanwhile, referring to FIG. 3, in the case where the aerobic thermophilic digestion bacteria were not added but the treatment was carried out with the general microbes, a temperature of 55° C. was attained only temporarily after the elapse of 48 hours, but a temperature of 50° C. was maintained most of the time.

This level of temperature can not provide a sufficient environment to annihilate all of the pathogenic microbes.

The foams that are produced within the treatment tank float up with the decomposition-resistant organic components of the slurry attaching on the surface.

The carrier path 23 that communicates to the air supply tube 6 has a negative pressure when the ventilating blower or the ejector-type agitating pump 5 operates. This negative pressure acts on the cyclone 18 and on the downstream portion of the foam-removing filter 17, so that the foams of the upper portion of the treatment tank are transferred from the foam inlet tube 16 to the foam-removing filter 17.

The foams introduced into the filter 17 are filtered with the filtering media. The solid ones are deposited onto the filtering media, while the liquid ones are recycled through the cyclone 18 and the tubular carrier path 23 into the treatment tank. Accordingly, in removing the foams, a driving power is not used, and therefore, it is economical.

Further, the components of the foul odor, which pass through the cyclone 18, are led from the top of the cyclone 18 through the cleaning tower 19 (which is provided with a showering facility) to the deodorizing tower 20, so that the discharged gas is odorless.

As shown in FIG. 3, the slurry temperature starts to drop after 96 hours. This is due to the fact that the decomposition of the slurry by the aerobic thermophilic digestion bacteria is stabilized. Although not illustrated in FIG. 3, the slurry temperature steeply drops down to around 40° C. thereafter.

At this point, the valve 10 of the microbe supply tubular path is switched, and the photo-tropic bacteria are fed from the photo-tropic bacteria accommodator into the treatment tank.

Then the photo-tropic bacteria start their activities under such a lower temperature environment to decompose the organic materials of the slurry. In accordance with the needs, the nutrient source for the photo-tropic bacteria is added through the second feeding hole 8, thereby promoting the proliferation of the photo-tropic bacteria.

Thus, if the proliferation of the photo-tropic bacteria is promoted before the other medium temperature microbes initiate their activities, then the generation of the foul odor is inhibited.

Thus, if a period of one week (168 hours) passes, most of the organic materials within the slurry are decomposed, and a part of the liquid is evaporated, thereby producing a liquid fertilizer, with the volume being reduced by 50% to 70%.

The liquid fertilizer is discharged from the bottom of the treatment tank to be stored into the liquid fertilizer reservoir 21 in which the pig hairs and the like are filtered off with the vibrator, before being carried to farms.

When the liquid fertilizer is produced, the pH-adjusting agent is supplied through the third feeding hole 9, so as to adjust the fertilizer to acidic or to alkaline. In this manner, any proliferations of various low temperature microbes and medium temperature microbes are inhibited, and any generation of foul odor is also prevented.

The liquid fertilizer includes within it the beneficent microbes such as the photo-tropic bacteria and the like. Further, not only are the three major nutrients including N, P and K contained, but also various minerals are included in large amounts.

Further, due to the high temperature sterilization, parasites and pathogens that are harmful to animals and plants are exterminated. Accordingly, when the liquid fertilizer is carried to farms, the fertilizer is in good working condition.

The liquid fertilizer of the present invention was used as a test case at the NAGANOGEN OHMACHISHI MIYATA farm to confirm its efficacy.

Test method:

Item: grownup FUJI apple trees

Use method: 3.5 t of the fertilizer was spread per 10 A.

Test result:

Two trees for both the fertilizer-spread area and the non-spread area were examined.

| | | | Fruit color | | Sugar content | |
|---|---|---|---|---|---|---|
| | g per fruit | Soil color | Dark | Bright | Dark | Bright |
| Liquid | 314.6 | 2.7 | 1.9 | 3.8 | 14.9 | 16.0 |
| fertilizer | | | | | | |
| area | | | | | | |
| Control - | 342.5 | 2.7 | 1.5 | 3.1 | 13.9 | 14.3 |
| Chemical | | | | | | |
| Fertilizer | | | | | | |

As can be seen in the above table, in the case where the liquid fertilizer was used, the color and sugar level of the fruits were improved.

Further, the liquid fertilizer of the present invention was used in paddy fields.

In the area where the fertilizer of the present invention was spread, the paddy plants were robust from their initial growth stage, that is, the efficacy of the liquid fertilizer was instant. Further, any fall-down or any abnormal extension of the lower segments of the paddy plants could not be observed.

Further, any occurrence of sickness or harmful worms could not be seen.

According to the present invention as described above, the following effects can be obtained.

The slurry type organic wastes are decomposed by utilizing the aerobic thermophilic digestion bacteria which stably flourishes at about 60° C. Then the decomposing is continued by utilizing the photo-tropic bacteria, thereby finally obtaining the product in the form of a liquid fertilizer.

The decomposing treatment can be continued for a long period of time at a high temperature, and the fermentation can be finished in a relatively short time period without generating any foul odor. Further, parasites and pathogens can all be annihilated.

Further, the slurry as the object of the treatment can be reduced in its volume, and the treatment can be carried out at a relatively low cost without using any water content adjusting agent.

Finally, the apparatus of the present invention is a simple facility, and its installation does not require a large area or space.

What is claimed is:

1. A method for treating a slurry type organic waste to produce a liquid fertilizer, the method comprising the steps of:
Adding the aerobic thermophilic digestion bacteria into a closed treatment tank, the tank accommodating an organic wastes slurry;
Aerating the treatment tank, for promoting a proliferation of the aerobic thermophilic digestion bacteria;
Treating the organic wastes slurry with a thermophilic fermentation; and
Adding photo-tropic bacteria so as to convert the organic waste slurry into a liquid fertilizer.

2. The method for treating a slurry type organic waste as claimed in claim 1, wherein nutrients for the microbes are added into the treatment tank in addition to the aerobic thermophilic digestion bacteria and the photo-tropic bacteria.

3. The method for treating a slurry type organic waste as claimed in any one of claims 1 and 2, wherein a microbe proliferation-inhibiting means is operated after the fermentation treatment.

4. The method for treating a slurry type organic waste as claimed in any one of claims 1 to 3, wherein the slurry type organic waste are made by adding the water into the organic waste which have the low water content.

5. The method for treating a slurry type organic waste as claimed in any one of claims 1 to 3, wherein the microbe proliferation-inhibiting means consists of a pH-adjusting agent

6. The method for treating a slurry type organic waste as claimed in claim 5, wherein the pH of the treated material is adjusted to over 10 or to below 3 by the pH-adjusting agent.

7. An apparatus for treating a slurry type organic waste to produce a liquid fertilizer, the apparatus comprising:
A closed treatment tank for accommodating the slurry type organic waste;
A group of microbes comprising photo-tropic bacteria and aerobic thermophilic digestion bacteria;
Means for putting the microbes into the closed treatment tank; and
Oxygen supply means for supplying oxygen into the closed treatment tank.

8. The apparatus for treating a slurry type organic waste as claimed in claim 7, further comprising: means for supplying nutrient for a microbe and/or pH-adjusting agent.

9. The apparatus for treating a slurry type organic waste as claimed in any one of claims 7 and 8, further comprising: means for removing foams formed within the treatment tank.

10. The apparatus for treating a slurry type organic waste as claimed in any one of claims 7 and 8, further comprising: means for heating the contents of the treatment tank.


SEQUENCE LISTING (2 sequences)

SEQ ID NO: 1 - DNA, 510 bp, Bacillus sp. AURACE-S
  n represents unknown 4, 5, 14, 21, 501, 504: 1~510 base pair of the 16s-rDNA derived from the Bacillus sp. AURACE-S
aggnngaacgctgngcggcgntgtcctaatacatgtcaaagtcgagcgaaccggatggagtgcttgcattcctgaggttagcggcggacgggtgagtaacacgtaggcaacctgcctgtacgaccgggataactccgggaaaccggagctaataccggataggatgccgaaccgcatggttcggcatggaaaggcctttgagccgcgtacagatgggcctgcggcgcattagctagttggtggggtaacggcctaccaaggcgacgatgcgtagccgacctgagagggtgaacggccacactgggactgagacacggcccagactcctacgggaggcagcagtagggaatcttccgcaatggacgaaagtctgacggagcaacgccgcgtgagtgaggaaggtcttcggatcgtaaaactctgttgtcagggaagaaccgccgggatgacctcccggtctgacggtacctgacgagaaagccccggctaactacgtgtcancanccgcgg

SEQ ID NO: 2 - DNA, 510 bp, B. stearothermophilus
  1~510 base pair of the 16s-rDNA derived from the B. stearothermophilus
aacgctggcggcgtgcctaatacatgcaagtcgagcggaccggattggggcttgctttgattcggtcagcggcggacgggtgagtaacacgtgggcaacctgcccgcaagaccgggataactccgggaaaccggagctaataccggataacaccgaagaccgcatggtcttcggttgaaaggcggcctttgggctgtcacttgcggatgggcccgcggcgcattagctagttggtgaggtaacggctcaccaaggcgacgatgcgtagccggcctgagagggtgaccggccacactgggactgagacacggcccagactcctacgggaggcagcagtagggaatcttccgcaatgggcgaaagcctgacggagcgacgccgcgtgagcgaagaaggccttcgggtcgtaaagctctgttgtgagggacgaaggagcgccgttcgaagagggcggcgcggtgacggtacctcacgagaaagcccggctaactacgtgccagcagccgcggt